(19) United States
(12) Patent Application Publication
(10) Pub. No.: US 2005/0226524 A1
(43) Pub. Date: Oct. 13, 2005

(54) Method and devices for restoring specific scene from accumulated image data, utilizing motion vector distributions over frame areas dissected into blocks

(75) Inventors: Kazumi Komiya, Zushi-shi (JP); Akihiko Watabe, Tokyo (JP); Tetsunori Nishi, Atsugi-shi (JP); Jun Usuki, Tokyo (JP); Shigeaki Hirata, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: TAMA-TLO Ltd., Tokyo (JP)

(21) Appl. No.: 11/059,654

(22) Filed: Feb. 17, 2005

(30) Foreign Application Priority Data
Apr. 9, 2004 (JP) 2004-114997

(51) Int. Cl. G06K 9/36

(52) U.S. Cl. 382/254

(57) ABSTRACT

Disclosed is a method of restoring specific scene whose objectives are to provide a specific scene restoration system having a sufficient detection rate enough to easily detect and pick up the specific scene from a plenty number of video data, or to detect in real time such scene as those whereon specific motions exist, comprising the steps of dissecting into k×k=N blocks( where N is 100 or less, desirably an integer in the range of 9 to 36) each frame of a motion video signal wherein a series of specific scenes to be restored are contained, calculating the motion quantities in each block using the total sum of the motion vector magnitudes in each block, obtaining a Mahalanobis distance D² for the images of said specific scenes, calculating a threshold defined by the average of D² plus standard deviation of D², comparing the threshold to the Mahalanobis distance D² calculated for each frame of the motion video signal to be retrieved, and by detecting the specific scene to be obtained on condition that the Mahalanobis distance in the latter is decided

### FIELD OF THE INVENTION

The present invention relates to a method and devices for easily picking up specific scenes or picking up in real time scenes in which specific motions exist, from a plenty number of video data, by defining the specific quantities characterizing the motions in the video frame to be displayed, in such video systems as those constituting storage devices for recording television broadcasting programs and video images, and in such systems as for monitoring video scenes.

The method and devices of the present invention can be applied to detect irregular scenes in the remote monitoring systems for monitoring the video images of traffics and/or security in malls, i.e., monitors for illegal parking, illegal drive and violence in traffics, and criminal offense; to detect designated scene on the video monitors of the video editors for broadcasting program service, digital libraries, and production lines; to retrieve desired information in the directory services utilizing multimedia technology, electronic commerce systems, and television shopping; and to detect desired scenes in the television program recorders and set-top boxes.

### BACKGROUND OF THE INVENTION

Multimedia telecasting has brought forth a new era in which a huge volume of video data are television-broadcast, and a variety of video contents are distributed to every home via the Internet which has become popular.

In the home appliance industry, inexpensive video recorders which can store a large volume of video contents have become practical due to advancement of optical technology e.g., DVD's and magnetic recording technology. Although a plenty amount of video contents( motion images) can easily be stored in the HDD recorders and home servers, database systems of new type are expected to be put into practical use so that everyone can restore the designated specific scenes every time and everywhere.

### Conventional Technologies

A patent document and non-patent documents 1 and 2 as the prior art disclose that each video frame on a video stream (a series of motion images) is dissected (or divided) into a plurality of blocks, and specific scenes are restored in accordance with the motion vector magnitudes found in each block. In accordance with the disclosed technologies in the prior art, whether the detected scenes are likely to the designated ones or not can be decided by statistically analyzing the information of the motion on the video stream, acquiring as the characteristic parameters the changes and their specific parameters in the motion quantities on the video stream, and comparing the specific parameters between the reference images and the target images to be retrieved.
Patent document: JP 2003-244628
Non-patent document 1: Akihiko Watabe, et al., “A study of TV video analysis and scene retrieval, based on motion vectors,” Technical Report of 204th Workshop, The Institute of Image Electronics Engineers of Japan, Sep. 19, 2003.
Non-patent document 2: “Character Recognition Using Mahalanobis Distance,” Takashi Kamoshita, et al., Journal of Quality Engineering Forum, Vol. 6, No. 4, August 1998.

The principle of operation of the specific scene restoration means as disclosed in both the patent document and the non-patent document 1 is as follows:
If averaged motion quantity M_{d} in each block of a series of arbitrary frames, on each of which a plurality of blocks are generated by dissecting each of said frames, for a plurality of frames constituting a series of target scenes which are requested to be retrieved, averaged motion quantity Mₚ in each block for a plurality of frames constituting an arbitrary scene to be retrieved, and standard deviation M_{sd} of the motion quantities in each block for a target scenes which are requested to be restored are related each other by the decision algorithm given by expression Mₚ−M_{sd}<M_{d}<Mₚ+M_{sd}, these blocks are called the fitted blocks. If the number of fitted blocks divided by the total number of dissected blocks on a series of frames exceed a threshold, said frames are restored as those belonging to the resembling scene.
On the other hand, non-patent document 2 discloses that the character recognition which recognizes the pattern of multi-dimensional information was studied using the Mahalanobis-Taguchi System(MTS).

### Problems in Conventional Technologies

When the specific scenes are detected from a series of target scenes to be retrieved, the detection rate( recognized as the precision of retrieving scenes) is defined in the disclosed technical materials as the percentage of the detected specific scenes to the total target scenes in number. The detection rate for detecting the resembling scenes includes the recall rate and precision rate in accordance with the non-patent document 1.

For instance, the recall rate and precision rate for the pitching scenes of baseball games are respectively defined as:
Recall rate=(Number of pitching scenes correctly decided.)/(Actual number of pitching scenes.)
Precision rate=(Number of pitching scenes correctly decied.)/(Number of pitching scenes decided in the retrieval.)

In accordance with the current technology level disclosed in the non-patent document 1, the maximum recall rate for the pitching scenes of a baseball game was 92.86 and the maximum precision rate was 74.59 at that time, of which the detection rates were unsatisfactory. Said technologies are considered suitable for generally restoring the designated scenes, but not for use in video databases where high detection rates are needed. High erroneous detection rates of said specific scene restoration means and devices might be due to the reasons which will be described hereafter.

In accordance with the technologies disclosed heretofore,
(1) Since the motion vector magnitudes on a series of blocks which have sequentially appeared in each block position on a plurality of contiguous frames are averaged, specific parameters defining the characteristics of the images are averaged with greater values of standard deviations, thereby causing the detection of erroneous scenes.
(2) The average and standard deviations, thereby defining the lower and upper bounds of the motion vector magnitudes in the respective block positions on the contiguous frames, will not define the correlation among the specific parameters in the respective block positions.
(3) The frame position whereat the motion vectors are abruptly changed needs to be detected, whereas no appropriate change detection means are provided, thereby making the detection rate low.

On the other hand, the non-patent document 2 provides the character recognition means utilizing multi-dimensional information, but not provide the specific scene restoration means having a sufficient detection rate enough to easily detect and pick up the specific scene from a plenty number of video data, or to detect in real time such scene as those whereon specific motions are existing.

In the non-patent document 2, the threshold to discriminate another data set to which other data of incidence belong, each containing a certain value of Mahalanobis distance, can be seen. However, none of these documents define the method of setting the threshold uniquely. The threshold is empirically set in accordance with the frequency distribution of incidence of data in a data set being compared with the reference scene.

### SUMMARY OF THE INVENTION

The objectives of the present invention are to provide the specific scene restoration systems having sufficient detection rates enough to detect the specific scenes satisfactorily in order to easily pick up the designated specific scenes from a plenty amount of video data, or in order to detect in realtime the scenes wherein the specific motions are existing.

The above objectives may be attained by a method of restoring specific scenes in which specific motion quantities will be defined by employing the motion vector distributions over the dissected block areas, i.e., the method and devices for restoring from the population of video contents the specific video contents which contain the designated specific scene (hereafter called the “reference scene”) that the customer wishes to watch; and comprises the followings steps of:
preprocessing of the video contents which have been prepared for use as the reference scene, control inputs to the system a series of S contiguous frames which constitute the reference scene, where S is the number of frames taken out as the samples;
dissecting each frame out of said S sample image frames representing the reference scene into N=k×k blocks, where N is an integer of 100>N>4, and desirably 36>N>9;
calculating the motion quantities m_{s,n} (where s=1 through S, and n=1 through N) for each block on the basis of the sum of the motion vector magnitudes in each block;
obtaining averages mₚₙ and standard deviations m_{sdn} by averaging said motion quantities m_{s,n} over S frames; obtains normalized motion quantities M_{s,n} in accordance with expression M_{s,n}=(m_{s,n}−mₚₙ)/m_{sdn};
generating a normalized matrix V consisting of said normalized motion quantities M_{s,n} as elements, a transposed matrix V^{t} of V, and an inverse matrix R⁻¹ of the correlation coefficient matrix R consisting of correlation coefficients among M_{s,n} as elements;
calculating a Mahalanobis distance Dₛ² given by expression Dₛ²=(V R⁻¹ V^{t})/N ( where s=1 through S) for the respective frames in the reference scene;
calculating the average and standard deviation of Dₛ² on the basis of the frequency distribution of incidence of Dₛ² when it is assumed as an independent variable;
calculating a threshold Dₜ² defined by the average of Dₛ² plus standard deviation of Dₛ²:
inputting to the system in sequence a series of frames (hereafter called the “frames to be decided”) recognized as the population of video contents in order to make a decision on the likelihood of the target scene to the reference scene;
dissecting each frame into N blocks in the same manner as above;
calculating motion quantities mₙ (where n=1 through N) in each block in the same manner as mentioned heretofore;
obtaining distances Mₙ (where n=1 through N) with expression Mₙ=(mₙ−mₚₙ)/m_{sdn}, given by distributed motion quantities mₙ referring to averaged motion quantities mₚₙ in said reference scene in units of standard deviations m_{sdn};
obtaining another Mahalanobis distance D² for the target frame, on which a decision is to be made, in accordance with expression D² =(V_{M} R⁻¹ V_{M}^{t})/N where normalized one-dimensional matrix V_{M} with said distances Mₙ as elements, a transposed matrix V_{M}^{t} of V_{M}, and an inverse matrix R⁻¹ of the correlation coefficient matrix R generated for said reference scene;
and making a decision that the target frame belongs to the scene resembling the reference scene on condition that D²≦Dₜ² is valid.

The Mahalanobis distance is defined as the squared distance measured from the center of gravity ( average ), divided by standard deviation, wherein the distance is given in terms of the probability.

The multi-dimensional Mahalanobis distance is a measure of distances among the correlated samples of frames distributed over the multidimensional space which are correlated each other by the correlation coefficients of a correlation coefficient matrix, and it can be used for precisely making a decision of whether a number of distributed samples of frames belong to a single group whose attribute resembles the reference scene. So, we can make a decision on whether a plurality of distributed samples belong to a specific group of samples or not, in units of said distance.

The high-precision, high-speed scene detection means can be realized wherein the specific scene can precisely be restored on demand from the video program contents of large volume at high speed.

Since the video monitoring system has a capability to detect the scene changes , it can detect irregular scenes with ease without any special video channel switching means, thereby making the monitoring of video contents easier.

### BRIEF DESCRIPTION OF THE DRAWINGS

FIG. 1 shows the flowchart of the operation of the specific scene restoration system built in accordance with the present invention.

FIG. 2 shows the block diagram of the specific scene restoration device built-in accordance with the invention.

FIG. 3 shows the Table of the dissected 3×3 block areas.

FIG. 4 shows the Table of basic data of the motion quantities for the respective blocks, giving an example of calculating Mahalanobis distance D².

FIG. 5 shows the Table of data of the normalized motion quantities for the respective blocks, giving an example of calculating Mahalanobis distance D².

FIG. 6 shows the Table of the correlation coefficients for correlation coefficient matrix R.

FIG. 7 shows the Table of the correlation coefficients for inverse matrix R⁻¹ of correlation coefficient matrix R.

FIG. 8 shows the Table of Mahalanobis distance D², giving an example of the calculations.

FIG. 9 shows the Table of the threshold set for making a decision on the likelihood of the target scene to the reference scene.

FIG. 10 shows the Table of the restoration of the specific scenes, resulting from the decision on the likelihood of the target scene to the reference scene.

FIG. 11 shows threshold Dₜ² in terms of the frequency distributions of incidence of Mahalanobis distance for both the pitching scene (reference scene) and the non-pitching scene, in which FIG. 11(a) shows typical frequency distributions of incidence of Mahalanobis distance, and FIG. 11(b) shows a pair of frequency distributions of incidence of Mahalanobis distance whose slopes are closely superimposed.

### DESCRIPTION OF THE PREFERRED EMBODIMENTS

### First Embodiment

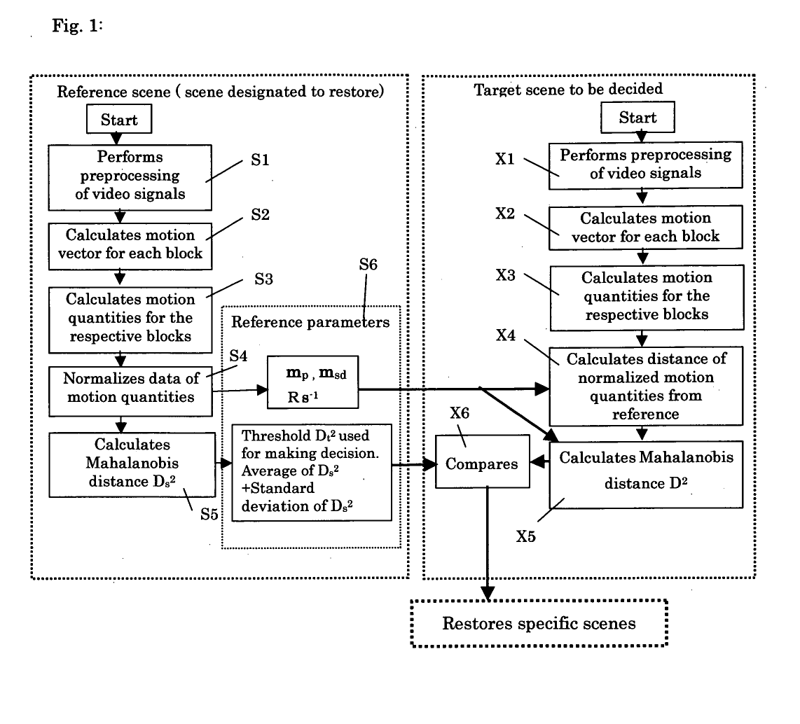

FIG. 1 shows the flowchart of the operation of a specific scene restoration means as a first embodiment of the present invention, on the basis of the motion vector distributions over the dissected block areas.

Control prepares the specific parameters (reference parameters) derived from the scene to be restored (called the reference scene ), on the basis of the flow (S1 through S6) in the left hand side of the flowchart of FIG. 1. The reference parameters consist of following 5 data items.
(a) Averages mₚₙ (where n=1 through N: N indicates the number of blocks, each constituting a unit frame of the reference scene.) of the motion quantities for the reference scene.
(b) Standard deviations m_{sdn} of the motion quantities for the reference scene, defined on the same condition as of (b).
(c) An inverse matrix R⁻¹ of correlation coefficient matrix R, whose elements define the correlation coefficients among the motion quantities for the respective blocks.
(d) A Mahalanobis distance Dₛ² calculated in terms of the respective S frames for the reference scene, where S indicates the number of frames taken out of the reference scene.
(e) The average and standard deviation of Dₛ² calculated on the basis of the frequency distribution of incidence of Dₛ² when it is assumed as an independent variable.
(f) A threshold Dₜ² defined by the average of Dₛ² plus u-times (0<u<3) the standard deviation of Dₛ², denoted as Dₛ² (average)+u*Dₛ² (standard deviation), where 0<u<3.

Next, a Mahalanobis distance D² is calculated for the scene which might contain the target scene on the video frames taken out of the population of the video contents, in order to decide on whether the scene taken out of said video contents resembles the reference scene or not, in accordance with the flow (X1 through X5) in the right hand side of the flowchart. During the calculation steps X1 through X5, specific parameters (a) through (e) are employed in terms of said reference scene.

Following the preprocessing steps mentioned above, control moves to the “compare” step (X6) shown at the bottom of the flowchart, and control makes a decision of whether D² is equal to or smaller than Dₜ² or not. On condition that D²≦Dₜ² is valid for the decision, control recognizes during the decision step that the series of contiguous frames, on which the decision has been made, belong to the frames which resemble those of the reference scene, and that this target scene is decided to be restored.

For obtaining the respective parameters mentioned above, control inputs contiguous S frames to the system for the reference scene, dissects the respective frames into N (=k×k) blocks. Control performs the processing for one target frame taken out of the video contents, on which the decision is to be made, at a time for making the decision. Each frame is dissected into N blocks in the same manner as for the reference scene. N is an integer in the range of 100>N>4, and desirably 36>N>9. These limited numbers are chosen to properly reduce the processing time of calculating the motion quantities for the respective target frames.

The motion quantity of each block is given by expression (1) on the basis of the motion vectors in each block as:

$$m = {\sum }_{i = 1}^{n} \vert {v}_{i} \vert \qquad ( 1 )$$

where m is the motion quantity, and Vᵢ is the motion vector. The upper bund n to subscript i is the number of units for calculating motion vectors in each block. For instance, if a frame is dissected into 9=3×3 blocks, and if each block consists of 10×15 unit cells, each consisting of 16×16 pixels for calculating motion vectors, n is given as 150 assuming that a frame consists of 720×480 pixels.

The Mahalanobis distance D² will be calculated in accordance with the following manner.
(1) A normalized matrix V is generated.
   Normalized data M is given by M=(m−mₚ)/m_{sd} in terms of average mₚ and standard deviation m_{sd} of motion quantity m.
(2) A transposed matrix V^{t} of said normalized matrix V is generated.
(3) A correlation coefficient matrix R is generated.

We obtain correlation coefficient matrix R for the motion quantities between the respective blocks on a frame, in terms of correlation coefficients given by the expression (2):

$${r}_{n m} = {r}_{m n} = \frac{1}{s} {\sum }_{s = 1}^{S} {M}_{n s} {M}_{m s} \qquad ( 2 )$$

where rₙₘ and rₘₙ are the elements of correlation coefficient matrix R for the respective motion quantities. Mₙₛ and Mₘₛ are the normalized motion quantities, respectively. S is the number of frames.

For instance, in case of a 3×3 matrix:
Rows: m=1, 2 . . . 9.
Columns n=1, 2 . . . 9.
Frames: S=20.
(4) An inverse matrix R⁻¹ of correlation coefficient matrix R is obtained.
(5) the Mahalanobis distance is calculated.

We obtain Mahalanobis distance D² of the motion quantities of the respective blocks on each frame, in accordance with S5 of FIG. 1, given by expression (3):
D²=(VR⁻¹V^{t})/N (3)
where N is the number of blocks.

On the other hand, the threshold to discriminate another data set to which other data of incidence, each containing a certain value of Mahalanobis distance, belong can be seen in non-patent document 2. However, none of these documents define the method of setting the threshold uniquely. The threshold is empirically set in accordance with the frequency distribution of incidence of data in a data set being compared with the reference scene.

In accordance with the method of the present invention, the threshold to discriminate whether the data set under consideration is that of reference scenes or that of non-reference scenes is set, taking into consideration the detection rates (the recall rate and precision rate) of the scenes to be picked up so that said pair of data sets are placed in the nearest positions on the Mahalanobis distance. Since the method of setting the threshold provides an objective decision criteria specified on the basis of the normalized statistical frequency distribution of incidence of data, the threshold is valid for all video contents, and in principle independent of the decision criteria for video contents.

We calculate the Mahalanobis distance Dₛ² for each of the frames containing the reference scene in order to make a decision on the likelihood between the target scene, on which the decision is to be made, and the reference scene; and calculate threshold Dₜ² for use in making the decision on said likelihood in terms of the average and standard deviations of Dₛ², which have been calculated for the contiguous S frames.

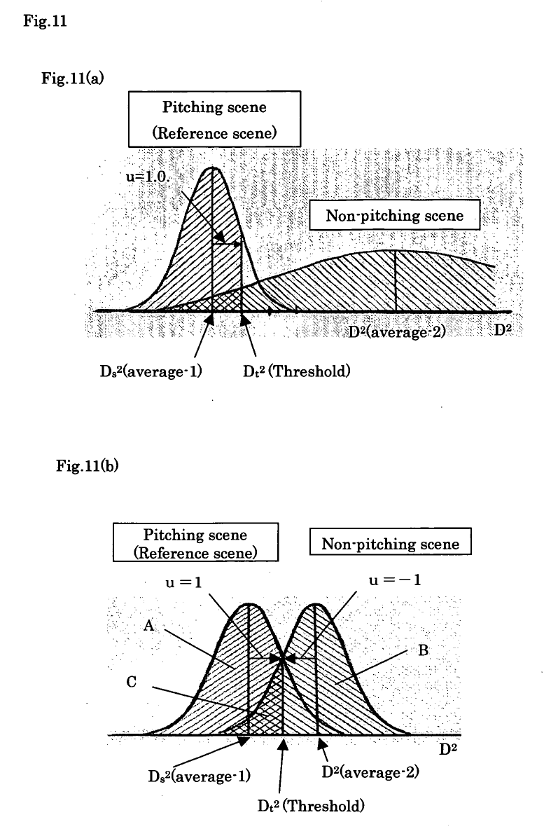

FIG. 11 shows the threshold Dₜ² in terms of the frequency distributions of incidence of the Mahalanobis distance for both the pitching scenes of a baseball (reference scene) and the non-pitching scenes in an embodiment, on which a decision is to be made, when the Mahalanobis distance is assumed as an independent variable. FIG. 11(a) shows typical frequency distributions of incidence of the Mahalanobis distance.

The frequency distribution of incidence of the Mahalanobis distance D² exhibits the highest frequency if D² is in its average, with decreasing frequencies around the average of D² (average-2).

The frequency distribution of incidence of Mahalanobis distance D² for each frame of the non-pitching scene, on which a decision is to be made, is defined by the distribution of the Mahalanobis distance measured from the reference scene, and the values of D² on the frequency distribution for the non-pitching scene occupy the range in which these values are generally larger than those of the reference scene. Deviations in the frequency distributions of incidence of the Mahalanobis distance D² are determined by the characteristics of the frames of the non-pitching scenes, on each of which a decision is to be made.

The recall rate and precision rate for the pitching scenes of a baseball game are respectively defined as:
Recall rate=(Number of pitching scenes correctly detected on the decision)/(Number of actual pitching scenes).
Precision rate=(Number of pitching scenes correctly detected on the decision)/(Number of scenes detected as the pitching scenes on the decision in the retrieval).

FIG. 11(b) shows a pair of frequency distributions of incidence of the Mahalanobis distance whose slopes are closely superimposed.

We assume that the standard deviations, each of which is defined as ‘u’, are of a pair of frequency distributions of D², and Dₛ² for the pitching scenes and non-pitching scenes are the same in value with different averages. These averages are denoted as Dₛ² (average-1 for the pitching scenes) and D² (average-2 for the non-pitching scenes). Then, we assume that Dₛ²(average-1)<D²(average-2)).

We assume that threshold Dₜ² which is defined by Dₛ² (average-1)+Dₛ²(standard deviation) for the pitching scene is the same in value as the threshold Dₜ² which is defined by D²(average-2)−D²(standard deviation) for the non-pitching scene.

In FIG. 11(b), the hatched area A shows the probability density of a pitching scene on the frames decided to be part of a pitching scene, the hatched area B shows the probability density of a non-pitching scene on a frame, and the meshed area C shows the probability density of a non-pitching scene on the frame erroneously decided to be part of a pitching scene.

Under these conditions, the recall rate is given by the hatched area A on the frequency distributions. The precision rata is given by A/(A+C) where C is the meshed area. A is given as 0.841 since u=1 and A/(A+C) is given as 0.841/1.00=0.841. When a pair of frequency distribution have the same value for u=1, the recall rate and precision are the same and it is 0.841. We can understand that the point of u=1 is the optimum point when the decision on the pitching scenes and non-pitching scenes can be made with recall and precision rates, each of greater than 80%.

Threshold Dₜ² is defined by the sum of the average of Dₛ² and u-times (0<u<3) the standard deviation of Dₛ², and so if ‘u’ is changed the any other value than unity taking account of the tradeoff between the recall and precision rates, these rates can be set at optimum values in accordance with the characteristics of the frames in which non-pitching scenes can appear.

If u=2.0, the recall rate is 0.9 and precision rate is 90/(90+50)=0.64. This implies that the recall rate goes high while the precision rate goes low.

### Second Embodiment

A method for restoring the specific scene of images will be described hereafter as a second embodiment of the present invention, which will be referred to in Claim 2 of the present invention.

Control obtains the Mahalanobis distance D² for the contiguous target frames, on which the decision is to be made, which have been input from the population of video contents; compares D² with the threshold Dₜ² obtained by the average and standard deviation of Dₛ² for the reference scene; and makes a decision on whether the target frames taken out of the population of video contents belong to the frames of the reference scene on condition that D²≦Dₜ² for a predetermined number or more of said contiguous target frames.

Means for detecting the scene changes will be cited as a variation of the second embodiment of the present invention, which will be referred as Claim 3 in the present invention.

Control obtains the Mahalanobis distance D² for the contiguous target frames, on which the decision is to be made, which has been input to the system from the population of video contents; compares D² with the threshold Dₜ² obtained by the average and standard deviation of Dₛ² for the reference scene; and makes a decision on whether said target scene taken out of the population of video contents indicates a scene change on condition that D²≦Dₜ² is valid for a predetermined number or more of said contiguous target frames, and thereafter the expression D²≦Dₜ² becomes invalid.

### Third Embodiment

A device for restoring the specific scene of images will be described as a third embodiment of the present invention, which will be referred to in Claim 4 of the present invention.

The device to restore from the population of video contents the specific video contents which contain the designated specific scene that the customer wishes to watch: In order to make a decision on the likelihood of the target scene to the reference scene, said device consists of a video signal preprocessing unit 12 which performs the preprocessing of the video frames (the target frame on which the decision is to be made) of the target scene which have been taken out of the population of the video contents which have been stored in video device 11, and dissects each of said video frames into N=k×k blocks, where N is an integer characterized by 100>N>4, and desirably 36>N>9; a motion vector calculation unit 13 which calculates the motion vectors in each block; a motion quantity calculation unit 14 which calculates the motion quantities m on the basis of the sum of the motion vector magnitudes in each block; a distance calculation unit 15 which calculates the distances of the distributed motion quantities from the reference parameter; a Mahalanobis distance D² calculation unit 16 which calculates the Mahalanobis distance D² for the target frame, on which the decision is to be made; a comparison unit 17; and a specific parameter holding unit 20 which calculates and holds the specific parameters (reference parameters) defined by the average mₚ and standard deviation m_{sd} of the motion quantities for the reference scene, an inverse matrix R⁻¹ of correlation coefficient matrix R for the motion quantities in each block, and the threshold Dₜ² defined by Dₛ² (average)+Dₛ² ( standard deviation) (threshold Dₜ² defined by the average of Dₛ² plus standard deviation of Dₛ²); and characterized by the comparison unit 17 which compares the Mahalanobis distance D² with the threshold Dₜ², and makes a decision on that the target frame belongs to the scene resembling the reference scene on condition that expression D²≦Dₜ² is valid.

### Fourth embodiment

FIG. 2 shows the block diagram of the device for restoring the specific scene which will be described referring to the pitching scene of a baseball game cited as a fourth embodiment in the present invention. In FIG. 2, a reference numeral 11 is assigned for the video device, 12 for the video signal preprocessing unit, 13 for the motion vector calculation unit, 14 for the motion quantity calculation unit, 15 for the distance calculation unit which calculates the distances of the distributed motion quantities from the reference parameter, 16 for the Mahalanobis distance D² calculation unit, 17 for the comparison unit, 20 for the specific parameter holding unit for the reference scene (scene designated to be restored), and 21 for the reference parameters for the reference scene (scene designated to be restored).

The video signal preprocessing unit 12 inputs video signals from such a video device as a television set or a DVD recorder, dissects a frame of the video signals into 9=3×3 blocks, and obtains the motion vector magnitudes in each block. The means to obtain the motion vector magnitudes are, in the present embodiment, the same as those which have been employed in the MPEG2 image compression device. We calculate the distance of motion measured by the moving object, which will be defined as the motion vector in units of blocks (each called a “macro block”: abbreviated as “MB” in the specification), each consisting of 16×16 pixels as a cell. The motion vector magnitude is defined by the minimum scalar value obtained by the calculation of expression (4) on the coordinates (a, b) within an MB. In case that a frame consisting of 720×480 pixels is dissected into 9=3×3 blocks, there are 150 MBs in each block.

$$\begin{matrix}\begin{matrix} Motion vector \\ Magnitude\end{matrix} \\ ( with no dimensions )\end{matrix} = {\sum }_{i , j = 0}^{15} {\sum }_{a , b = 0}^{15} \vert {X}_{i , j , k} - {X}_{i \pm a , j \pm b , k - 1} \vert \qquad ( 4 )$$

where X indicates the value (eg., brightness) of the pixel. Subscripts i and a respectively indicate the specified values of positions on the ordinate within an MB, and j and b respectively on the abscissa within an MB. Character k indicates the frame number. Expression (4) calculates for all a- and b-values the differences between the values of positions of pixels on the ordinate i and abscissa j within the MB having the frame number k, and those of pixels on the ordinate i±a and abscissa j±b within the MB having the frame number k−1; then calculates the sum of these absolute values on the respective ordinate and abscissa, resulting in the motion vector quantities (motion vector magnitudes).

We calculate the sum of the motion vector magnitudes, of which each magnitude has been obtained for the respective MB, in each block employing expression (1); then we define the sum of the motion vector magnitudes in each block as the motion quantity.

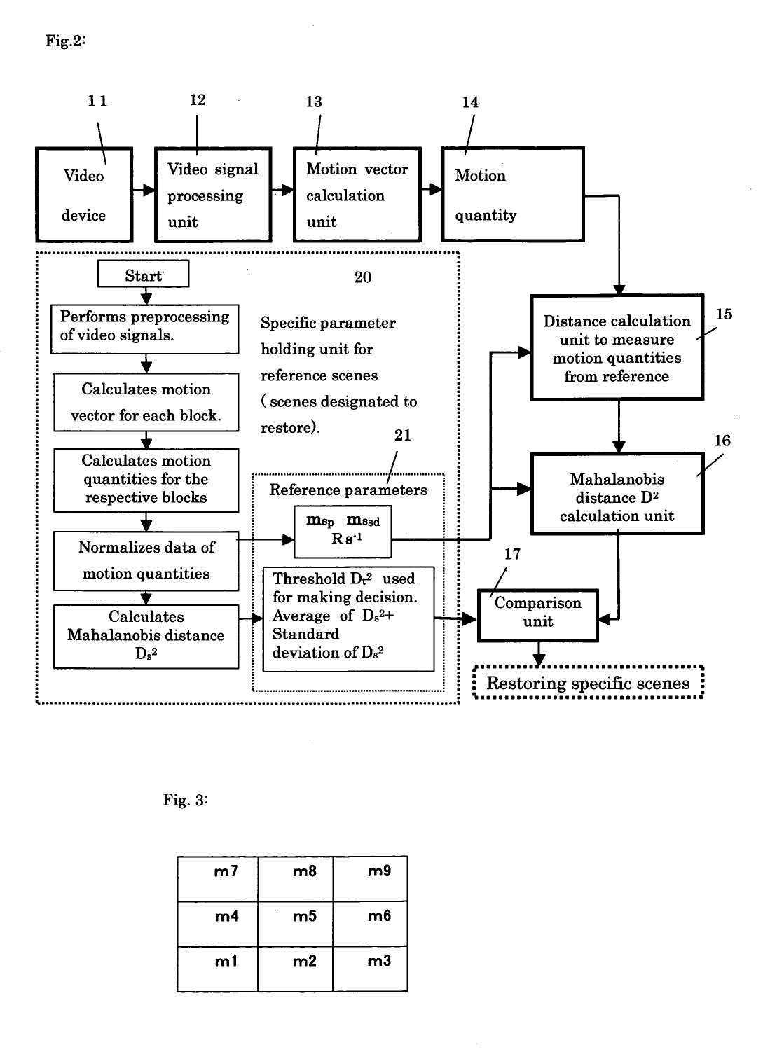

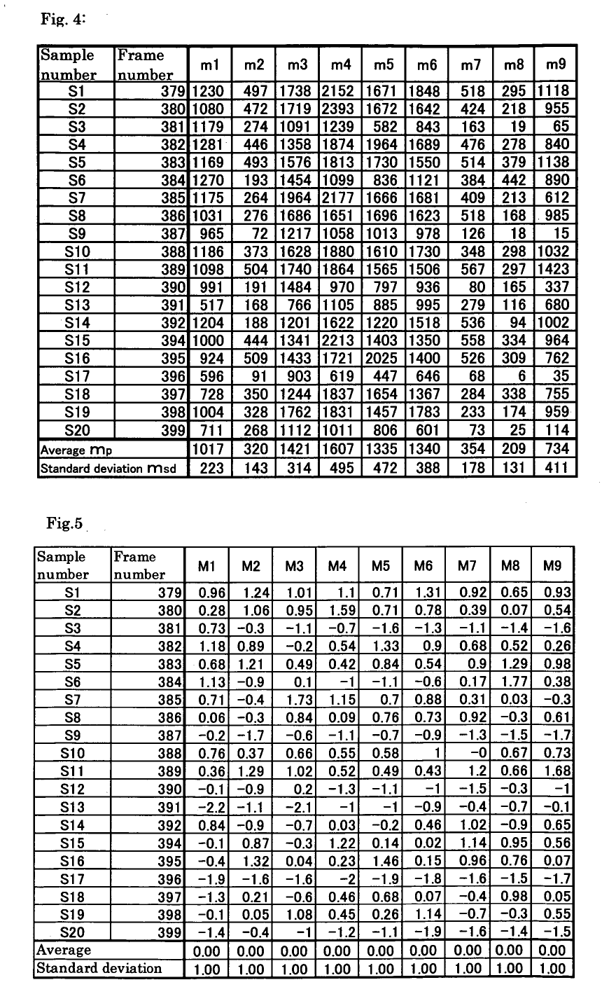

We dissect a frame into 9=3×3 blocks as shown in FIG. 3, and obtain motion quantities m₁ through m₉ for the respective blocks within said frame in accordance with the motion vectors for the respective blocks. We define these parameters as basic data of motion quantities for the respective blocks. FIG. 4 shows basic data of the motion quantities for the respective blocks. We obtain normalized matrix V of the normalized motion quantities in accordance with expression M_{s,n}=(m_{s,n}−mₚₙ)/m_{sdn} employing average mₚₙ and standard deviation m_{sdn} of motion quantities m_{s,n} in each block. FIG. 5 shows normalized data of motion quantities for each block.

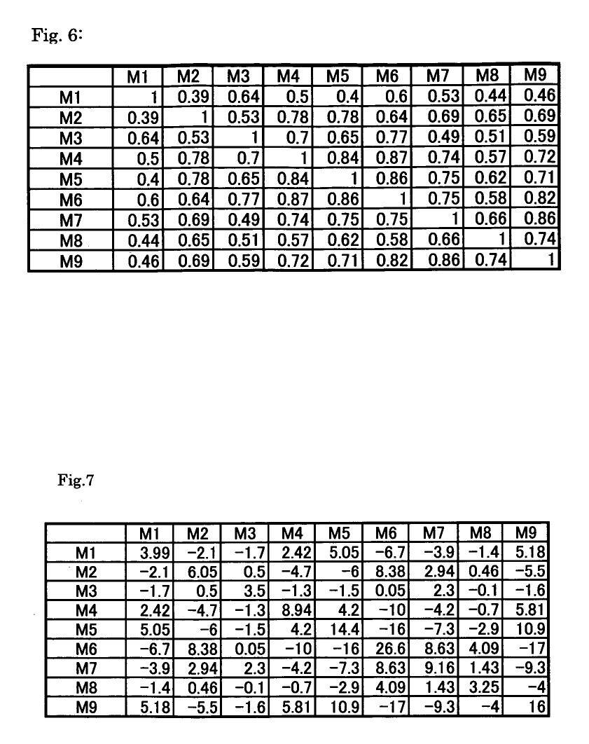

Next, we obtain for said normalized data, element r of the correlation coefficient matrix R of motion quantities among the respective blocks within a frame. FIG. 6 shows the elements of correlation coefficient matrix R. Employing the elements set to matrix R, we obtain inverse matrix R⁻¹ of the correlation coefficient matrix R as shown in FIG. 7.

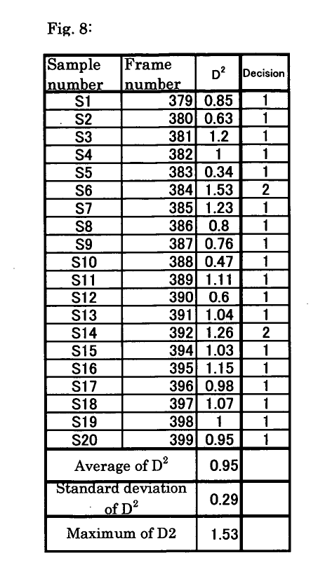

We then calculate a normalized matrix V, a transposed matrix V^{t} of V, a correlated coefficient matrix R of motion quantities among the respective blocks within a frame, thereby obtaining an inverse matrix R⁻¹ of R, and the Mahalanobis distance Dₛ² of the motion quantities among the blocks in each frame. FIG. 8 shows an example of the Mahalanobis distance Dₛ².

FIG. 8 shows how to set the threshold for the reference image (reference scene), and how to make the decision in accordance with the threshold. In accordance with the decision criteria, if the Mahalanobis distance D² is greater than the threshold, control recognizes the scene under test as the non-pitching scene; if the Mahalanobis distance D² is smaller than the threshold, control recognizes the scene under test as the pitching scene.

The threshold defined by the average of the Mahalanobis distance Dₛ² for the reference scene plus its standard deviation, which are denoted as Dₛ² (average)+Dₛ² (standard deviation), is given as 0.95+0.29=1.24. FIG. 8 shows a series of the Mahalanobis distances D², wherein sample frames of the non-pitching scene with a threshold of greater than 1.24 are S6 and S14 in FIG. 8.

### Fifth Embodiment

A fifth embodiment of restoring the specific scene s in accordance with the present invention will be described referring to a total number of 800 frames, on which the decision is to be made, consisting of 20 pitching scenes and other 20 non-pitching scenes (a total of 40 scenes) of a baseball game.

We dissected a frame into 9=3×3 blocks, and calculated Mahalanobis distance D² for each frame in accordance with the motion quantity in each block.

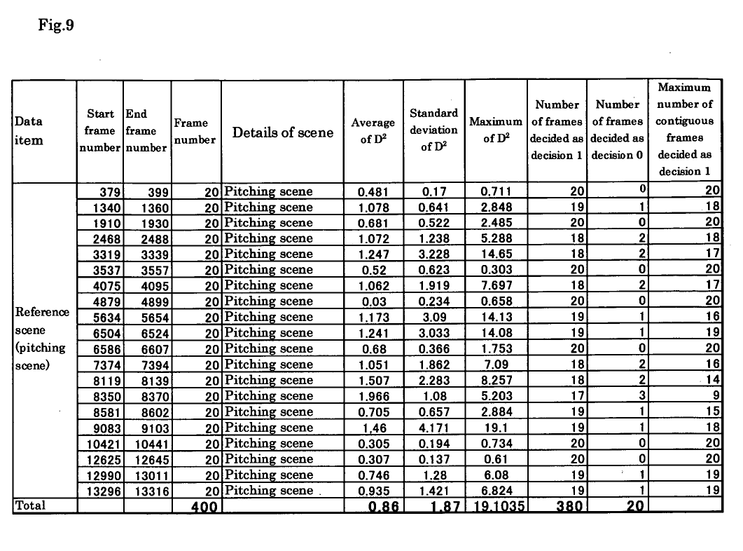

The specific parameters for the reference scene are prepared in accordance with FIG. 9. FIG. 9 shows how to set the threshold for making the decision on the likelihood of the target scene to the reference scene.

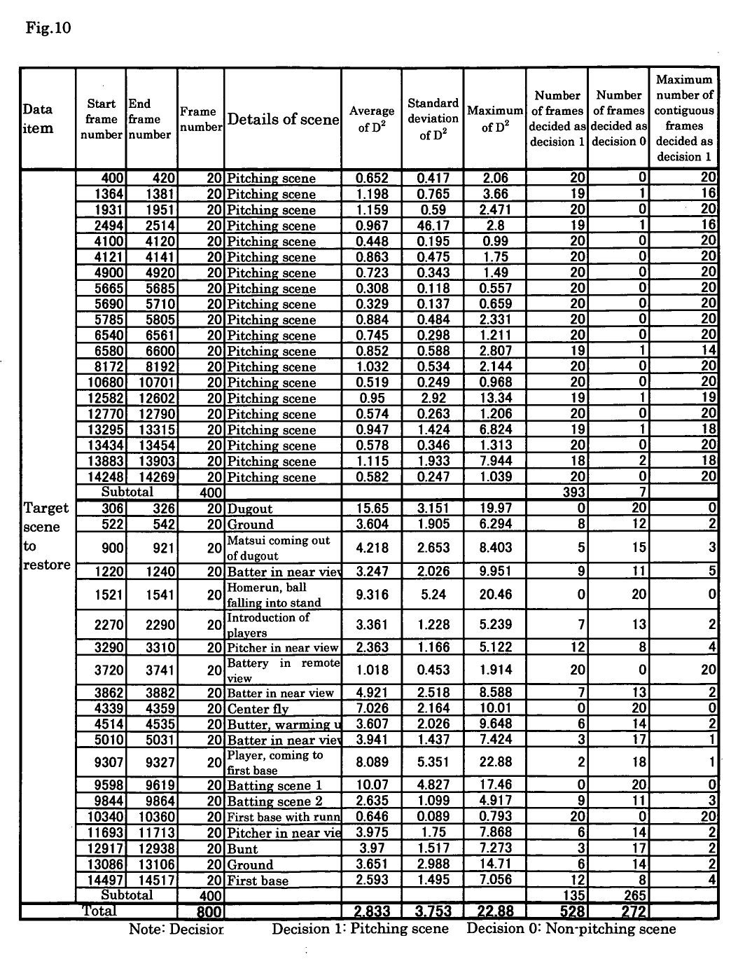

FIG. 10 shows the specific scenes restored on the basis of the decision of the likelihood.

The recall and precision rates for the respective frames being retrieved are as follows:
(1) Recall rate for the frames=393/400=98%.
(2) Precision rate for the frames=393/921=43%.

Decision 1 (in case of D²≦Dₜ²) made in accordance with Mahalanobis distance D² has appeared contiguously for the pitching scenes, but not for the non-pitching scenes.

When the number of frames contiguously decided as decision 1 (implying a pitching scene) is defined to be 7 or more in accordance with the decision criteria, we obtain a recall rate for the scenes of 20/20=100% and a precision rate for the scenes of 20/22=90%. The means to improve the decision rate are cited in Claim 2 in the present invention.

In this case, control needs not detect the scene change which has been set forth as a preliminary condition for the means to restore the specific scenes in the specific scene restoration device cited in both patent document 1 and non-patent document 1.

How to detect the scene changes in the specific scenes referring to Claim 3 of the present invention will be described in case of pitching scenes. FIG. 10 shows an example of the result of restoring the specific scenes, wherein the number of contiguous frames recognized as decision 1 is 9 or more for the pitching scenes and the number of contiguous frames recognized as decision 1 is 5 or less in most of the non-pitching scenes. So, if the number of contiguous frames recognized as decision 1 is 7 or less, control makes a decision that the pitching scene is replaced by the other scene due to scene change.

1. A method of restoring from the population of video contents a specific scene which contains the designated specific scene (hereafter called the “reference scene”) that the customer wishes to watch, comprising the steps of
preprocessing video contents which have been prepared for use as the reference scene;
inputting to the system a series of S contiguous frames which constitute the reference scene, where S is the number of frames taken out as the samples; dissects each frame out of said S sample image frames representing the reference scene into N=k×k blocks, where N is an integer characterized by 100>N>4, and desirably 36>N>9;
calculating motion quantities m_{s,n} (where s=1 through S, and n=1 through N) for each block on the basis of the sum of the motion vector magnitudes in each block;
obtaining averages mₚₙ and standard deviations m_{sdn} by averaging said motion quantities m_{s,n} over S frames;
obtaining normalized motion quantities M_{s,n} in accordance with expression M_{s,n}=(m_{s,n}−mₚₙ)/m_{sdn};
generating a normalized matrix V consisting of said normalized motion quantities M_{s,n} as elements, a transposed matrix V^{t} of V, and an inverse matrix R⁻¹ of correlation coefficient matrix R consisting of correlation coefficients among M_{s,n} as elements;
calculating a Mahalanobis distance Dₛ² given by expression Dₛ²=(V R⁻¹ V^{t})/N (where s=1 through S) for the respective frames in the reference scene;
calculating the average and standard deviation of Dₛ² on the basis of the frequency distribution of incidence of Dₛ² when it is assumed as an independent variable;
calculating a threshold Dₜ² defined by the average of Dₛ² plus the standard deviation of Dₛ²:
inputting to the system in sequence a series of frames recognized as the population of video contents in order to make a decision on the likelihood of the target scene to the reference scene;
dissecting each frame into N blocks in the same manner as mentioned heretofore;
calculating motion quantities mₙ (where n=1 through N) in each block in the same manner as mentioned heretofore;
obtaining distances Mₙ (where n=1 through N) with expression Mₙ=(mₙ−mₚₙ)/m_{sdn}, given by distributed motion quantities mn referring to averaged motion quantities mₚₙ in said reference scene in units of standard deviations m_{sdn};
obtaining Mahalanobis distance D² for the target frame, on which a decision is to be made, in accordance with expression D²=(V_{M} R⁻¹ V_{M}^{t})/N where normalized one-dimensional matrix V_{M} with said distances Mₙ as elements, its transposed matrix V_{M}^{t}, and inverse matrix R⁻¹ of correlation coefficient matrix R generated for said reference scene; and
making a decision that the target frame belongs to the scene resembling the reference scene on condition that D²≦Dₜ² is valid.

2. A method according to claim 1,
wherein control makes a decision that the target scene taken out of the population of video contents belongs to the reference scene on condition that D²≦Dₜ² is valid for a predetermined number or more of the contiguous target frames.

3. A method according to claim 1,
wherein control makes a decision that the target scene taken out of the population of video contents is replaced by other scene in accordance with the scene change on condition that D²≦Dₜ² has been valid for a predetermined number or more of contiguous target frames and thereafter the expression D²≦Dₜ² becomes invalid.

4. A device for restoring from the population of video contents a specific scene which contains the designated specific scene that the customer wishes to watch, comprising:
a video signal preprocessing unit which performs the preprocessing of the video frames (the target frames on which the decision is to be made) of the target scene which has been taken out of the population of the video contents in order to make a decision on the likelihood of the said target scene to the reference scene, and dissects each of said video frames into into N=k×k blocks, where N is an integer characterized by 100>N>4, and desirably 36>N>9;
a motion vector calculation unit which calculates the motion vectors in each block;
a motion quantity calculation unit which calculates the motion quantities mₙ on the basis of the sum of the motion vector magnitudes in each block;
a distance calculation unit which calculates normalized distance Mₙ measured from average mₚₙ to distributed motion quantities mₙ for said reference scene (n=1 through N) in units of standard deviation m_{sdn}, employing expression M_{,n}=(mₙ−mₚₙ)/m_{sdn}, provided that average mₚₙ and standard deviation m_{sdn} of motion quantities mₙ have been calculated for the reference scene,
a Mahalanobis distance calculation unit which calculates Mahalanobis distance D² for the target frame, on which a decision is to be made, in accordance with expression
D²=(V_{M} R⁻¹ V_{M}^{t})/N
where normalized one-dimensional matrix V_{M} given in terms of said distances Mₙ as elements, its transposed matrix V_{M}^{t}, and inverse matrix R⁻¹ of correlation coefficient matrix R with correlation coefficients among the motion quantities in the respective blocks, which has been calculated for the reference scenes, and
a comparison unit which compares said Mahalanobis distance D² with threshold which has been calculated for the likelihood of the target scene (to be decided) to the reference scene,
characterized by making the decision that the target scene being decided resembles the reference scene on condition that the Mahalanobis distance D² for the target frame being decided is equal to or smaller than the threshold Dₜ².
to be equal to or smaller than the threshold in the former in comparison.
